(19) United States
(12) Patent Application Publication
(10) Pub. No.: US 2011/0110431 A1
(43) Pub. Date: May 12, 2011

(54) METHOD OF CODING AND DECODING A STREAM OF IMAGES; ASSOCIATED DEVICES

(75) Inventors: Guillaume Laroche, Rennes (FR); Naël Ouedraogo, Maure De Bretagne (FR)

(73) Assignee: CANON KABUSHIKI KAISHA

(21) Appl. No.: 12/940,516

(22) Filed: Nov. 5, 2010

(30) Foreign Application Priority Data
Nov. 9, 2009 (FR) 0957916

(51) Int. Cl. H04N 7/32

(52) U.S. Cl. 375/240.16; 375/E07.243; 375/E07.027

(57) ABSTRACT

A method of coding a stream of images that are divided into blocks comprising, for a block to code, a motion compensating step during which a residue is calculated from said block to code and from a reference block chosen as predictor, characterized in that it comprises a step of resilience filtering applied to at least one reference block, during which high frequencies of original content of at least one part of the reference block are filtered to obtain a blurred reference block, a step of calculating a residue using the blurred reference block as predictor in a motion compensating step, and a step of processing said residue for it to be coded.

### BACKGROUND

1. Field

The invention relates to a method of coding a stream of images, to an associated decoding method, as well as to associated devices.

2. Related Art

The video coding algorithms concerned are the algorithms which exploit the spatial and temporal redundancies of the images, for example the algorithms standardized by the standardization organizations ITU, ISO, and SMPTE.

In this context the invention provides a tool for resilience against errors linked to data losses.

In coding of the type in the standard H.264/AVC, the original signal is cut up into blocks, and these blocks are coded either in Intra mode or in Inter mode, on the basis of decomposition of each block into the sum of a predictor that is already known and a residue, specific to the block and which has to be sent. An Intra predictor is identified by a predictor index. An Inter predictor is identified by a motion vector and a reference image index.

For the Inter coding mode, the best predictor block is selected from among blocks of the stored images referred to as “reference images”, during a process termed motion estimation. The predictor is subtracted from the current block, this step being called motion compensation.

The block residue generated, whether in Inter or Intra coding, is transformed using a DCT (“Discrete Cosine Transform”) function and then quantized. The transformed and quantized residue is then coded using an entropy coder (such as an arithmetic coder), before being inserted in the bitstream with the number of the Intra predictor, in case of Intra coding, or with a motion vector and a reference image index in case of Inter coding.

In the coding of the type in the H.264/AVC standard, there are more particularly three types of images, I, P and B. The I images are solely coded in Intra. The P images use Intra and Inter coding with reference images that are solely in the past. The B images use Intra and Inter coding with reference images in the past or in the future.

The video streams that are transferred onto telecommunication networks may be damaged by data losses. The parts of the images represented by those lost pieces of stream cannot be decoded normally. Furthermore, Intra or Inter pixel dependencies cause propagation of the errors in other parts belonging either to the current image or to the following images. The visual effect or more precisely the visual error on the sequence amplifies, image by image, until the sequence is refreshed by an Intra image.

In order to limit the visual impact of the pixel losses on the video sequence when decoded and displayed, tools for error resilience have been developed in the state of the art.

Firstly, algorithms for refreshing the signal are known. This refreshment may be a retransmission of the lost or damaged signal or an insertion of Intra images or blocks whose reference signal does not depend on the lost pixels. Several types of Intra refreshment may be distinguished.

Firstly, in a context without transmission of messages from the decoder to the coder, Intra images are frequently inserted in the stream in order to limit the duration of the propagation of errors. This method however has disadvantages. To be precise, the difference between the last Inter image which contains errors and the Intra image which refreshes the sequence causes a visual effect comparable to a change in scene. The fact of correcting the propagation of errors is then more visible than the propagation of errors itself.

Furthermore, the frequent use of Intra images has a significant impact on the rate and thus on the quality, since for the same rate an Inter image has a better quality than an Intra image.

An alternative to frequent refreshment of the signal is the transmission by the decoder to the coder of a request asking for the refreshment of the signal solely when this is judged necessary by the client, using a process called “Feed back channel”.

When the coder receives this request, it inserts an Intra image in the stream. This makes it possible at the same time to attenuate the visual impact of the refreshment and to limit the impact of the Intra images on the rate. However, this method may only be applied in the case of communication between the decoder and the coder, which is inconceivable for the applications of non-interactive program broadcasting to several clients for example.

Lastly, the so-called “adaptive Intra refresh” algorithms use Intra blocks in regions having a high probability of error propagation. Unfortunately, these methods cause visual effects of flicker due to the differences between the blocks coded in Intra and the neighboring blocks containing errors.

In this context, from the document “Advanced Video Coding for Generic Audiovisual Services”, ITU-T Recommendation H.264 and ISO/IEC 14496-10 (MPEG-4 AVC). ITU-T and ISO/IEC JTC, chapter “Decoding process” section “deblocking filter,” a deblocking filter is known which corrects the block effects created by high quantization, by smoothing the borders between the blocks. The filter for correcting the edge effects is applied solely at the block edges. This filter has an effect limited to those block effects, and does not affect the other visual drawbacks mentioned above.

Furthermore, error concealment algorithms are known that are used in decoders to provide a visual approximation of an image or of a part of the image which has been lost or damaged on transmission of the bitstream. The visual approximation provided by these algorithms affects the following images and amplifies image by image. Two types of error concealment algorithms are distinguished: so-called temporal algorithms and so-called spatial algorithms.

In the spatial error concealment algorithms, the information of the damaged image that have been correctly reconstructed are used to provide a visual approximation. For example, the lost pixels are replaced by pixels equal to the neighboring pixels, or to an average of those neighboring pixels. These means may be weighted on the basis of the spatial distance of the neighboring pixels relative to the lost pixels, or on the basis of the direction of an edge identified in the image near the lost pixel.

Methods using an error concealment algorithm are also known which provide, at both the coder and at the decoder, an approximation of the pixels lost during the transmission by virtue of a return transmission of “feed back channel” type for image loss information, the approximation being obtained on the basis of information correctly transmitted and decoded. This method can only be implemented in case of communication between the decoder and the coder. It moreover leads to a modification of the transmitted images, and thereby a loss in quality.

From the document US 2008/0310506 “Joint Spatio-Temporal Prediction for Video Coding” a coding mode is known for improving the coding performance based on a new predictor block. This predictor is the sum of the high frequencies of an Inter predictor and of the low frequencies of an Intra predictor. The residue contains less information, but the visual effects linked to error propagation are still present.

This analysis of the state of the art shows that the known methods have insufficient robustness for the high frequencies.

### SUMMARY

In this context, the invention provides a method which limits the propagation of errors and eliminates the different visual effects referred to above, by increasing the robustness of the transmission for the high frequencies. Furthermore, the cost in terms of rate used is limited relative to the cost incurred by coding of Intra type.

To obtain this result, a method is provided of coding a stream of images that are divided into blocks comprising, for a block to code, a motion compensating step during which a residue is calculated from said block to code and from a reference block chosen as predictor, characterized in that it comprises a step of resilience filtering applied to at least one reference block, during which high frequencies of original content of at least one part of the reference block are filtered to obtain a blurred reference block, a step of calculating a residue using the blurred reference block as predictor in a motion compensating step, and a step of processing said residue for it to be coded.

By virtue of this method, the residues sent over the network are enriched with the high frequencies of original content of the coded blocks. Thus, on decoding, resilience is obtained against the loss of high frequency information and against error transmission. A better visual quality for the viewer results from this. In case of packet losses, a soft reconstruction of the lost image pieces is also obtained.

Importantly, the same filter is applied at the coder and at the decoder.

It is to be noted that the resilience filtering applied to at least one reference block may be carried out on an isolated block or on a block within a reference image of which all the blocks (or at least some of the blocks) are subjected to the resilience filtering. Thus, between the resilience filtering step and the step of calculating a residue, there may be a step of extracting a block from a reference image.

The blurred reference block is used in the step of calculating a residue regardless of any coding cost criterion, for example regardless any rate-distortion criterion. According to an object of the invention, the blurred reference block is used systematically, i.e. each time a residue is calculated.

It is also to be noted that it is determined which high frequencies relate to the origin content for example by a step of analyzing at least one reference block, or by a step of analyzing available coding parameters, as presented later, or by a combination of such steps.

According to an advantageous feature, the processing step comprising a step of quantizing the residue, the reference block is obtained by a step of preparing the reference block including a step of dequantizing a block residue.

This feature makes it possible to benefit, during the coding process, from a form of the reference blocks which, like that which is available for the decoder, has undergone quantization and dequantization, these processing steps introducing losses in the content of the image.

According to an advantageous feature, the reference block is obtained by a step of preparing the reference block, which, when the predicting step is an inverse motion compensating step, uses a decoding predictor block, itself obtained by a step of preparing the decoding predictor block that includes a step of resilience filtering.

This feature makes it possible to benefit, during the coding process, from a form of the reference blocks which is the same as that which is available for the decoder, since the inverse motion compensation has been carried out with a decoding predictor that underwent a resilience filtering step.

According to another advantageous feature, the process further comprises, prior to a motion estimating step during which the reference block is selected, a step of image reconstituting and a step of correction filtering that filters the high frequencies on the basis of a characteristic of the image reconstituting step.

Thus, the block effects introduced into the reconstituted reference image at the time of its reconstitution can be attenuated.

The method may thus involve two high frequency filtering steps, of which the first is a step of correction filtering linked to the step of reconstituting the image, and the second is a step of loss resilience filtering.

Moreover, according to an advantageous feature, the step of resilience filtering is applied to a plurality of blocks of a set from at least one reference image to obtain a set of at least one blurred reference image, said blurred reference block being chosen, from within the set from at least one blurred reference image, using a motion estimating step between the steps of resilience filtering and of calculating a residue. By virtue of this feature, the compression of the data stream is increased.

According to another advantageous feature, the step of resilience filtering comprises at least one application of a blurring mask to a pixel, consisting of replacing the value of said pixel by the average of the values of at least one set of pixels that are neighbors of said pixel.

This feature makes it possible to process each pixel of the image in an individualized manner and which may thus be differentiated while removing the high frequencies, by a blurring operation, and while keeping the low frequencies in a manner that is simple to implement.

According to another advantageous feature, the step of resilience filtering comprises a step of determining a matrix of intensity of processing comprising for each pixel of the reference image a value representing an intensity of processing to be carried out.

This feature enables each pixel of the image to be processed in differentiated manner. In particular, the processing applied may be blurring as presented earlier, and the processing intensity is then a number of successive applications of the mask, i.e. a parameter of extent of the mask, indicating for example a number of direct or indirect neighbor pixels, over which the average is taken.

According to another advantageous feature, the value representing an intensity of processing is a number of applications of the same processing to be carried out. Alternatively, the value could represent a characteristic of intensity relative to processing carried out only once.

According to another advantageous feature, the step of resilience filtering is carried out on the basis of at least one value representing a spatial variability of at least one reference block.

This makes it possible to take into account the presence of high frequencies in the reference block, or even in the reference image if the value representing a spatial variability is measured by analysis of the image reconstituted from several blocks, in the resilience filtering process. The spatial variability at a point is measured for example by a gradient, and for example, the higher the gradient at a point, the more the filtering applied at that point is intensified.

According to another advantageous feature, the step of resilience filtering is carried out on the basis of at least one value representing a temporal variability of at least the reference block.

This makes it possible to take into account the intensity of the movements present in the images, in the resilience filtering process. The temporal variability at a point may be measured by a motion gradient, for example the gradient of the motion of the block containing the point. For example, the higher the motion gradient at a point, the more the applied filtering is intensified.

According to another advantageous feature, the step of resilience filtering is carried out on the basis of at least one indicator of a coding mode of the image of which the reference block forms part.

In particular, the indicator may relate to the prediction mode used for the image. This feature improves the visual quality of the video stream transmitted. The invention provides for the process to be adapted, for example by intensifying the resilience filtering when the image is a P image.

According to another advantageous feature, the step of resilience filtering is carried out on the basis of at least one speed of the video image stream.

This feature, taking into account for example the number of images per second, enables the visual quality of the transmitted video stream to be improved. For example, the lower the number of images per second, the more the resilience filtering carried out is intensified.

According to another advantageous feature, the step of resilience filtering is carried out on the basis of at least one temporal distance between the block to which the resilience filtering is applied and an image coded autonomously later, for example the first later Intra image.

This feature enables the visual quality of the video stream transmitted to be improved. Advantageously, more intense filtering is applied if the first later Intra image is far off.

According to another advantageous feature, the step of resilience filtering is carried out on the basis of at least one parameter representing a traffic state of a network over which the stream of images is transmitted.

This makes it possible to take into account the level of congestion of the network, which affects the risks of data losses between the server and the client. Advantageously, more intense filtering is applied if the rate of loss is high.

According to another advantageous feature, the step of resilience filtering is carried out on the basis of at least one quantization step size used in the residue processing step.

This feature enables the visual quality of the video stream transmitted to be improved. Advantageously, more intense filtering is applied if the quantization step size is small.

The invention also concerns a method of decoding a stream of images that are divided into blocks comprising, for a residue to decode, a step of inverse motion compensation during which a block is calculated from said residue to decode and a reference block serving as predictor, characterized in that it comprises a step of resilience filtering applied to at least one reference block, during which high frequencies of at least one part of said reference block are filtered to obtain at least one blurred reference block, and a step of calculating a decoded block using the blurred reference block as predictor in an operation of inverse motion compensation.

By virtue of this decoding method, used with an associated coding method using the same resilience filter, the video stream may be decoded without losses in case of transmission without losses. The coded blocks are enriched, by the decoder, with the high frequencies of the received residues by virtue of the coding method according to the invention. Furthermore, resilience is obtained against the loss of high frequency information and against transmission errors. A better visual quality for the viewer results from this. In case of packet losses, a smoothed reconstruction of the lost image pieces is also obtained.

According to an advantageous feature, if a loss of data from the image stream is identified before the reference filtering step, an error concealment algorithm using motion extrapolation is used to replace the lost data.

The choice of such an error concealment algorithm in the context of the decoding method gives improved performance.

The invention also relates to a device for coding a stream of images that are divided into blocks adapted to perform, for a block to code, motion compensation during which a residue is calculated from said block to code and from a reference block chosen as predictor, characterized in that it comprises means for resilience filtering adapted to be applied to at least one reference block, to filter high frequencies of original content of at least one part of the reference block and obtain a blurred reference block, means for calculating a residue adapted to use the blurred reference block as predictor in a motion compensating step, and means for processing said residue for it to be coded.

Such a coding device has advantages deduced from the advantages presented above concerning the coding method.

It is also to be noted that it is determined which high frequencies relate to the origin content for example by virtue of means for analyzing at least one reference block, or of means for analyzing available coding parameters, as presented herein, or by a combination of such means.

The invention also concerns a device for decoding a stream of images that are divided into blocks which, for a residue to decode, is adapted to perform inverse motion compensation during which a block is calculated from said residue to decode and a reference block serving as predictor, characterized in that it comprises means for resilience filtering adapted to be applied to at least one reference block, for filtering high frequencies of at least one part of said reference block and to obtain at least one blurred reference block, and means for calculating a decoded block adapted to use the blurred reference block as predictor in an operation of inverse motion compensation.

Such a decoding device has advantages deduced from the advantages presented above concerning the decoding method.

The invention also provides a computer program comprising a series of instructions adapted, when they are executed by a microprocessor, to implement a coding method as defined above.

The invention also provides a computer program comprising a series of instructions adapted, when they are executed by a microprocessor, to implement a decoding method as defined above.

### BRIEF DESCRIPTION OF THE DRAWINGS

The invention will now be described in detail with reference to the accompanying drawings.

FIG. 1 shows the general diagram of a video encoder of the state of the art.

FIG. 2 shows the general diagram of a video decoder of the state of the art.

FIG. 3 shows a device architecture adapted to implement the invention.

FIG. 4 shows the general diagram of a video encoder including the modules provided by the invention.

FIG. 5 shows the general diagram of a video decoder including the modules provided by the invention.

FIG. 6 shows the diagram of the resilience filter and the parameters used in the invention.

FIG. 7 shows the diagram of a video encoder according to a variant of the invention.

FIG. 8 shows the diagram of a video encoder according to another variant of the invention.

FIG. 9 shows the diagram of a video encoder according to another variant of the invention.

FIG. 10 shows the diagram of a video encoder according to another variant of the invention.

### DESCRIPTION

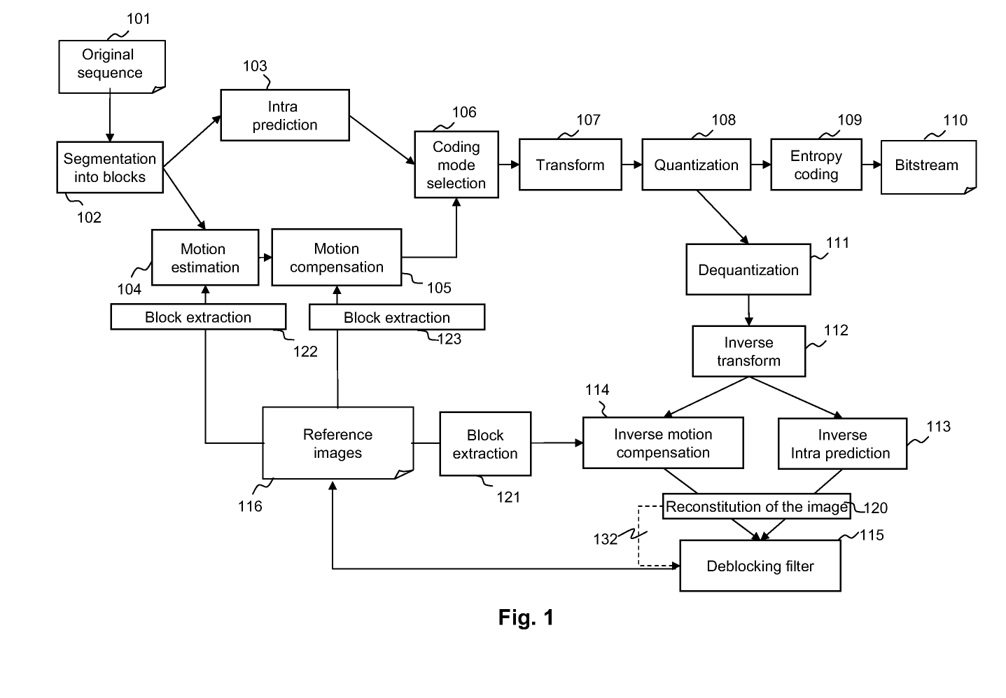

With reference to FIG. 1, video coding of H.264/AVC type is shown. It should be noted that the video coding standard of reference, H.264/MPEG-4 AVC, is the result of the collaboration of the “Video Coding Expert Group” (VCEG) of the ITU and of the “Moving Picture Experts Group” (MPEG) of the ISO.

The original sequence is a succession of digital images 101 produced during a prior step of producing the original sequence. A digital image is represented by one or more matrices of which the coefficients represent pixels.

In the H.264/AVC standard, the images are segmented into “slices”, a slice being a part of the image or the whole image. The slices are segmented into macroblocks (blocks of size 16 pixels×16 pixels), the macroblock being the coding unit in the standard. Each macroblock may be cut up into different sizes of blocks during the segmenting step carried out by the segmenting module 102. It is to be noted that, in the accompanying Figures, the modules applying an algorithm are presented by a simple rectangle, whereas the information processed or produced by the modules is represented by a rectangle with a bent corner.

Each block forms the subject of Intra prediction during a predicting (or estimating) step implemented by the Intra prediction module 103, i.e. Inter prediction during steps of motion compensation and estimation, implemented by modules 104 and 105. These two types of prediction provide several texture residues which are compared during a step of selecting the best coding mode by the selection module 106.

In the Intra prediction module 103, the current block is predicted using an Intra predictor block, that is to say a block which is constructed from information already encoded from the current image.

For the Inter coding, a motion estimation between the current block and reference images 116 is carried out by the motion estimation module 104 during a motion estimating step. Generally, the motion estimation 104 is a block matching algorithm (BMA). The block contained in one of the reference images is used as predictor of the current block. The residue (the difference between the current block and the predictor block) is calculated by the motion compensation module 105 during a compensating step.

The residue selected by the selection module 106 is then transformed by the transformation module 107 during a transforming step then quantized by the quantization module 108 during a quantizing step. The coefficients of the transformed and quantized residue are next coded during a step of entropy or arithmetic coding implemented by the entropy coding module 109 and then inserted into the bitstream 110 during an inserting step. In the remainder of the document, only entropy coding will be mentioned. However, it may easily be replaced by arithmetic coding.

If Intra coding is selected by the selecting module 106 during the selecting step, an item of information enabling the Intra predictor block used to be described is furthermore transmitted from the Intra prediction module 103 to the entropy coding module 109 (transmission not shown), and coded during the coding step 109 before being inserted into the bitstream 110 during the inserting step.

If the module for selecting the best coding mode 106 has chosen Inter coding, an item of motion information is transmitted from the motion compensation module 105 to the entropy coding module 109 (transmission not shown), coded during the coding step by the coding module 109 and inserted into the bitstream 110 during the inserting step. In the standard of reference, this item of motion information is composed of a motion vector and of a reference image index.

The group of steps implemented by the modules 107, 108 and 109 constitutes a step of processing the residue for the purpose of its coding.

The step of preparing the reference block used by the motion compensation module 105 will now be described.

It is advantages for the Intra predictor blocks and the Inter predictor blocks used for the motion compensation to be extracted from reference images reconstructed on the basis of blocks already encoded then decoded. For this, a so-called “decoding loop” is inserted into the coder (see references 111, 112, 113, 114, 120, 115, 116, 121, 122 and 123). The transformed and quantized residue is dequantized by a dequantization module 111 during a dequantizing step and reconstructed during a step of inverse transformation implemented by the inverse transformation module 112.

If the residue comes from Intra coding, the corresponding Intra predictor block is added to that residue during a step of inverse Intra prediction implemented by the inverse prediction module 113. If the residue comes from Inter coding, the block belonging to the reference image 116 is added to the decoded residue during a step of inverse motion compensation by the inverse motion compensation module 114. In this step, the Inter predictor block is identified by an item of motion information coming from the motion compensation module (transfer of this information not shown). This item of motion information is composed of a motion vector and of a reference image index.

A reconstituting step is next proceeded to which is implemented by the module 120 for reconstituting an image using the blocks thus calculated.

It is then sought to attenuate the block effects in the reference images, by attenuating the artificial high frequencies introduced at the boundaries between blocks. These blocks effects are created by high quantization of the residue. To attenuate them, the coder and the decoder of the H.264/AVC standard integrates a deblocking filter in the module 115 applying a filtering step to the image so produced. This step is carried out using information 132 sent to the filter 115 by the image reconstituting module 120. This information is in particular the size of the blocks used. For a full explanation of the operation of the de-blocking filter, reference should be made to the document cited in the prior art.

The deblocking filter 115 enables the edges between the blocks to be smoothed in order to visually attenuate the high frequencies created by the coding. The filtered images are stored in the module “reference images” 116.

The reference images 116 are then used for extending the blocks necessary at the steps of motion estimation 104, and motion compensation 105.

Respectively, these uses involve extractions of block 122 and 123. It is to be noted that the extraction of block 122 for the motion estimation 104 is carried out for numerous blocks sequentially.

The extraction of the block for the motion compensation is carried out on the basis of an item of information supplied to the module for extraction of block 123 by the motion estimation module 104, this item of information being the identifier of the block to extract, chosen at the time of the motion estimation process.

The set of the steps of dequantization 111, inverse transformation 112, inverse motion compensation 114 or inverse Intra prediction 113, of reconstitution of the image 120 and of correction filtering 115 constitutes the step mentioned above of preparing the reference block.

The reference images 116 are next used to extract the blocks necessary for the inverse motion compensating steps 114, called decoding predictor blocks. The extraction of block 121 for the inverse motion compensation is made on the basis of the motion information. The set of the steps of dequantization 111, inverse transformation 112, inverse motion compensation 114 or inverse Intra prediction 113, of reconstitution of the image 120 and of correction filtering 115 also constitutes the step of preparing the decoding predictor block.

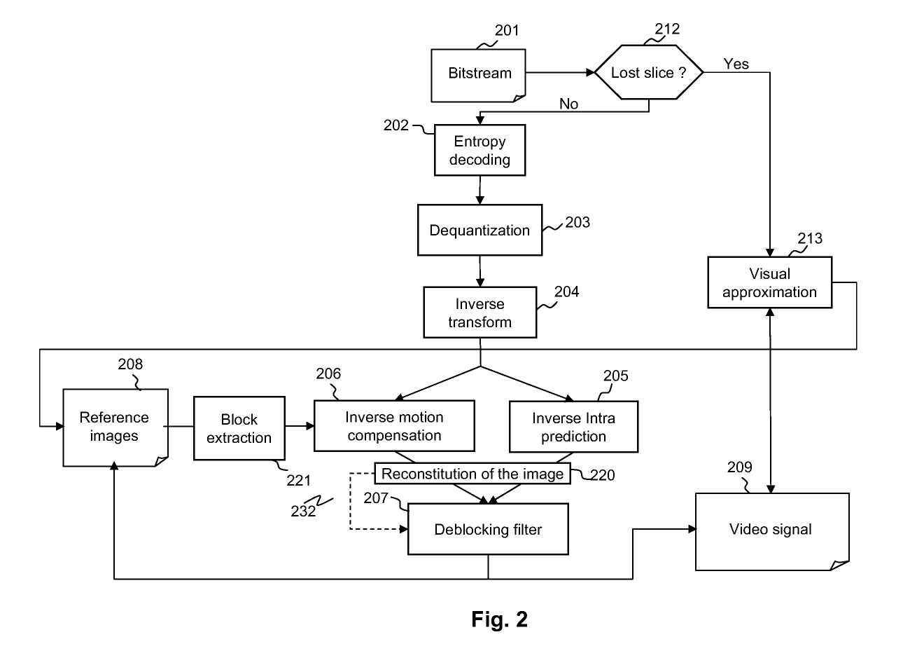

FIG. 2 represents a video decoder of H.264/AVC type. The bitstream 201 is received, and is subjected to a test to establish whether it is complete and correct during a testing step implemented by a test module 212.

Where the stream is judged to be complete and correct, that is to say that no image or image portion (slice) has been lost, it is made to undergo entropy decoding during a step of entropy decoding implemented by an entropy decoding module 202. The residue of the current block is next dequantized during a dequantizing step implemented by a dequantization module 203, then reconstructed during a step of inverse transformation implemented by an inverse transformation module 204.

The coding mode of the current block is extracted from the bitstream and made to undergo entropy decoding (also during the step of entropy decoding in FIG. 2, but, in variants, it is possible for the decoding of the stream and that of the coding mode not to be carried out simultaneously).

If the current block is of Intra type, the number of the predictor is extracted from the bitstream and made to undergo entropy decoding. The Intra predictor block associated with this index is added to the dequantized reconstructed residue in the inverse Intra prediction module 205 during a step of inverse Intra prediction.

If the coding mode of the current block indicates that this block is of Inter type, the motion estimation information is extracted from the bitstream and decoded. This motion information is used in an inverse motion compensation module 206 during a step of inverse motion compensation making it possible to calculate a decoded block from the residue produced by the inverse transformation module 204, to determine the Inter predictor block contained in the reference images 208. The step of inverse motion compensation also uses a predictor block extracted from a reference image 208, on the basis of the motion information.

At the end of the decoding of the current image a deblocking filter 207 which is identical to that used at the coder (reference 115 in FIG. 1) is used to eliminate the block effects contained in the reference images 208. It uses information 232 sent to the filter 207 by the image reconstitution module 220. This information is in particular the size of the blocks used.

These decoded images constitute the video signal 209 output from the decoder. They are also kept as reference images 208 for the motion compensation process.

When an image or an image portion (slice) is lost during transmission over the network between the server and the client, this is identified during the testing step by the test module 212 and no information for that image can be extracted from the bitstream.

In this case, an approximation of that image is made using error concealment algorithms, by a visual approximation module 213. This visual approximation depends on the signal already coded 209.

In the execution of the method, the steps implemented by the modules 202 to 206 are replaced by an error concealment algorithm in the execution of the algorithm commencing at the entropy decoding step (module 202), in case of absence of degradation of the stream identified at the test step (module 212). It produces an estimated image.

It is to be noted that these algorithms are not standard-based; they therefore depend on the particular implementation of each decoder.

The deblocking filter 207 may or may not be applied to the estimated image. The estimated images are included in the video signal 209 and kept in memory with the other images in the reference image module 208. The reference images form the subject of a block extraction process 221 for the motion compensation 206.

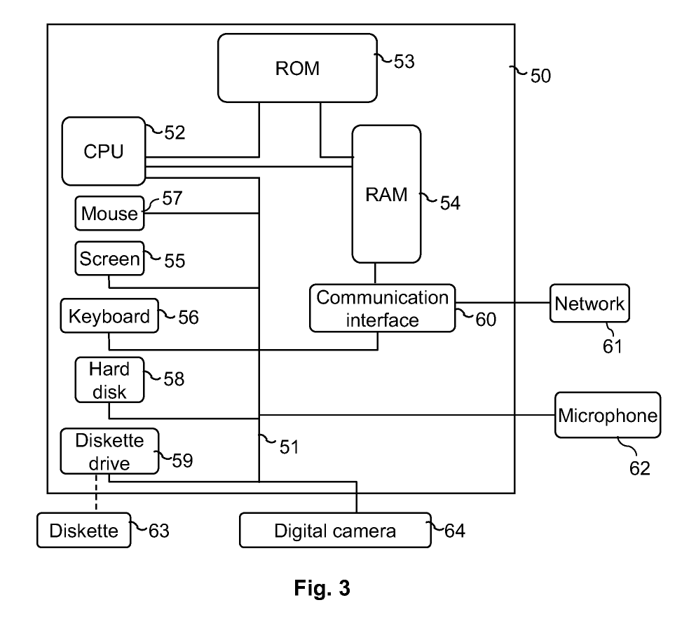

FIG. 3 illustrates an example of a device 50 adapted to incorporate the invention, in a particular embodiment.

Preferably, the device 50 comprises a central processing unit (CPU) 52 capable of executing computer program instructions coming from a read only memory (ROM) 53 on powering up of the device, as well as instructions concerning a software application coming from a main memory 54 after powering up.

The main memory 54 is for example of random access memory (RAM) type and operates as a working zone of the CPU 52. The memory capacity of the RAM 54 may be increased by an optional RAM connected to an extension port (not illustrated).

The instructions concerning the software application may be loaded into the main memory 54 from a hard disk 58 or else from the program ROM 53 for example.

Generally, a means for storing information which may be read by a computer or by a microprocessor, is adapted to store one or more programs of which the execution enables the implementation of the method according to the invention.

This storage means is integrated into the device 50 or not, and may possibly be removable. The execution of the program or programs mentioned above may take place, for example, when the information stored in the storage means is read by the computer or by the microprocessor.

When the software application is executed by the CPU 52, it leads to the execution of the steps of the method according to the invention.

The device 50 further comprises a network interface 60 which enables its connection to the communication network 6.

The device 50 may further comprise a user interface, comprising for example a screen 55, a keyboard 56 or a pointing device 57 such as a mouse or an optical stylus, to display information for a user or to receive inputs from the user. This interface is optional.

The device 50 is for example a micro-computer, a workstation, a digital assistant, a portable telephone, a digital camcorder, a digital photographic camera, a video surveillance camera (for example of webcam type), a DVD reader, a multimedia server or a router element in a network.

The device 50 may include a digital image sensor, or be connected to different peripherals such as a microphone 62, a digital video camera 64, a scanner or any means for image acquisition or storage connected to a graphics card and supplying the apparatus with multimedia data. The device 50 may also have access to multimedia data on a storage medium (for example the hard disk 58 or the diskette drive 59 and the diskette 63) or may receive a multimedia stream to process, for example coming from a network.

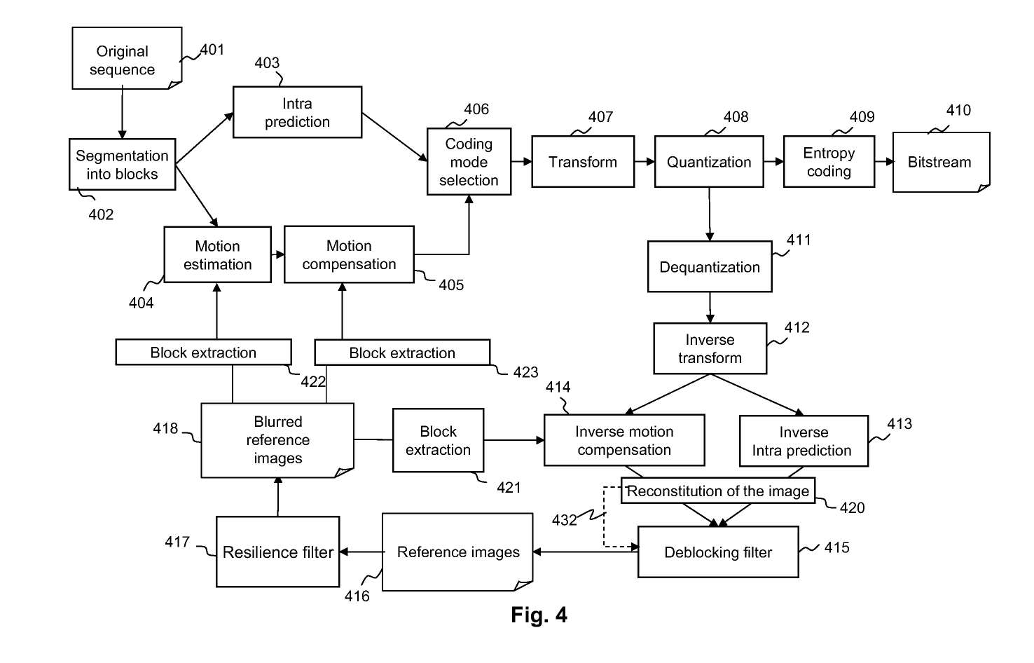

FIG. 4 represents the general diagram of a video encoder according to the invention. The modules 401 to 415 are analogous to the modules 101 to 115 of FIG. 1. In particular the motion compensation module 405 enabling a residue cancelling step to be implemented is familiar.

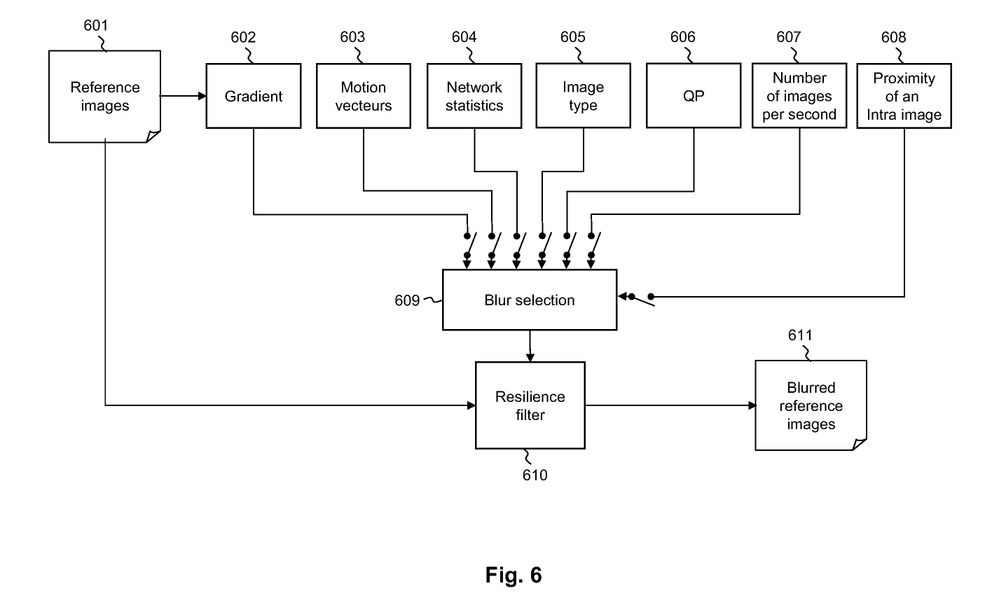

The difference compared with the coder of FIG. 1 lies in the processing of the reference images. The modules 417 and 418 in the coder of FIG. 4 have been added to module 116 of FIG. 1, here numbered 416. The reference images 416 produced by the deblocking filter 415 are filtered during a step of resilience filtering implemented by a resilience filtering module 417. An implementation of this step of resilience filtering will be detailed below with reference to FIG. 6.

The images obtained as output from the resilience filter 417 are so-called blurred reference images 418. These blurred reference images 418 are used in the process of inverse motion compensation 414, of motion estimation 404 and of motion compensation 405 (via steps of blurred reference block extraction carried out by the modules 421, 422 and 423 respectively). It is observed that, on the contrary, in the prior art represented in FIG. 1, the corresponding modules directly use the reference images 116.

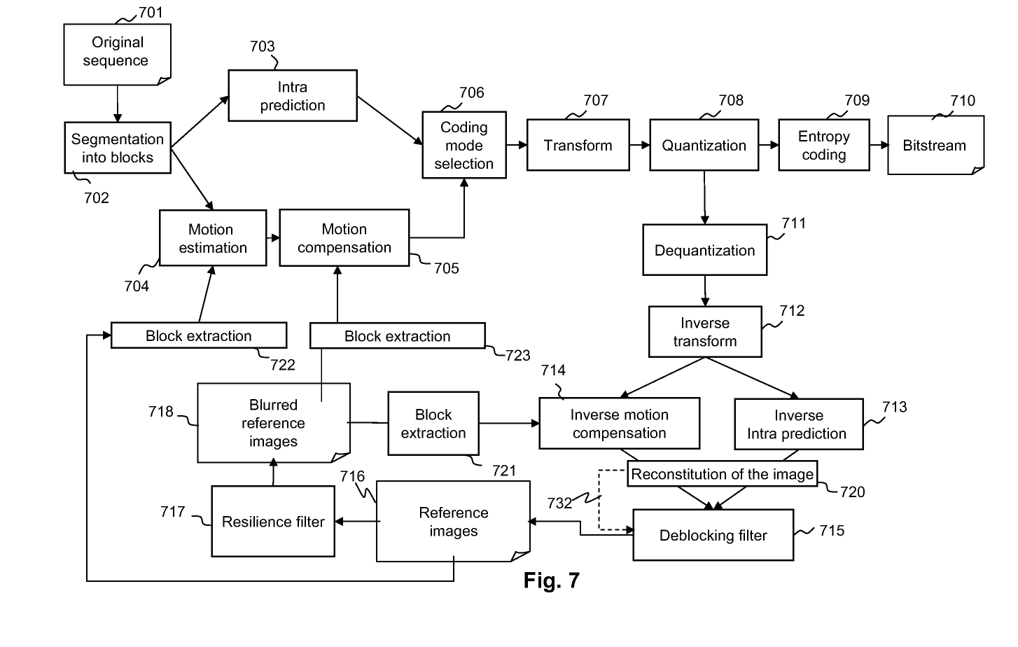

It is to be noted that the motion estimation 404 is carried out on the basis of the blurred reference images 418. This aspect will be returned to with reference to FIG. 7.

As previously in FIG. 1, the group of steps implemented by the modules 407, 408 and 409 constitutes a step of processing the residue for the purpose of its coding.

As mentioned with reference to FIG. 1, the set of the steps of dequantization 411, inverse transformation 412, inverse motion compensation 414 or inverse Intra prediction 413, of reconstitution of the image 420 and of correction filtering 415 also constitutes a step of preparing the reference block.

This set of steps also constitutes a step of preparing the decoding predictor block, used in the step of inverse motion compensation carried out by the module 414.

It is to be noted that the correction filter 415 is not indispensable to the implementation of the encoder according to the invention.

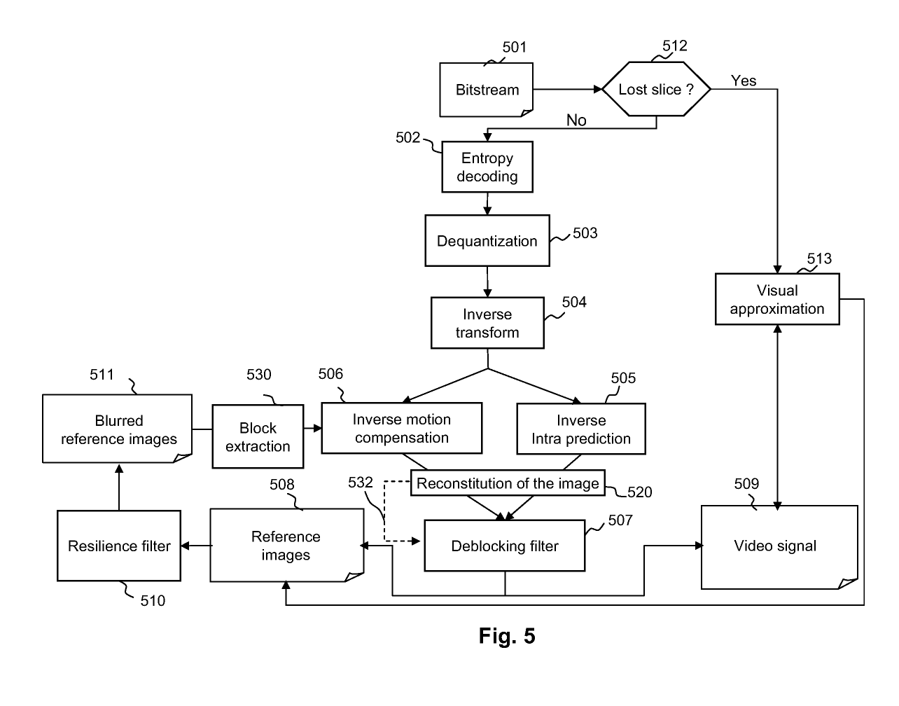

FIG. 5 represents a video decoder according to the invention. The modules 501 to 508 are analogous to the modules 201 to 208 of FIG. 2. The inverse motion compensation module 506 enabling a step of calculating a decoded block is in particular once again present.

However, the reference images 508 obtained after the application of the deblocking filter 507 are the subject of resilience filtering by application of the resilience filter 410, which produces blurred reference images 511. The processing for the inverse motion compensation 506 is carried out by selecting the predictor block of the current block in the blurred reference images 511.

However, the video signal 509 resulting from the decoding (steps implemented by the modules 502, 503, 504, 506 and 520) is unmodified relative to the decoder of FIG. 2, in the embodiment presented, since no module is inserted between the deblocking filter 507 and the module 509 for reconstituting the video signal.

When, at the test step 512, it is found that an image or an image piece has been lost during the transmission from the coder to the decoder, an error concealment algorithm replaces modules 502 to 507 and 520.

The error concealment algorithm implemented by module 513 which gives the best performance with the resilience filter 510 is an algorithm for extrapolating the motion of the image preceding the lost image. However, the invention is compatible with other types of error concealment algorithms.

The estimated image or the estimated image piece, integrated into the reference images 508, is filtered by a resilience filter 510 and serves as blurred reference image 511 necessary for the inverse motion compensation implemented by the module 506 applied to the following images in the stream 501.

With this method, the difference between the image obtained by application of the error concealment module 513 and the resilience filter 510 contained in the module 511 and the theoretical image which would have been obtained without loss between the coder and the decoder and processed by the same decoding modules 502, 503, 504, 506, 520 and 507 and the same resilience filter 510 is generally less than the difference which is obtained between those two images without application of the resilience filter (that is to say in FIG. 2, at module 208). Consequently, in case of transmission loss and application of an error concealment algorithm, the reference images used by the decoder are closer to the reference images used at the coder when a resilience filter (417, 510) is applied.

The difference between two images may be measured by the difference in the pixel to pixel absolute values between the images.

More particularly, the error concealment algorithms which may be used in block 513 are more effective for reconstructing the low frequencies than for reconstructing the high frequencies. Moreover, these concealment algorithms create high frequency artifacts which are also attenuated by the resilience filter.

By virtue of this reduction in the error at block 511, the visual impact, at block 509, of the loss of an image on the following images is attenuated compared with a device not integrating the resilience filter 510.

Lastly, the predictors for Inter blocks used for the motion compensation 405 of the coder and the inverse motion compensation 414 of the coder and 506 of the decoder contain few high frequencies, since they are chosen in the modules 418 and 511 for storage of the blurred reference images. Consequently, the high frequencies are contained in the block residues transmitted in the bitstream 410.

In case of data loss between the coder and the decoder, these high frequencies of the block residues enable progressive reconstruction of the visual errors during the course of the following images.

The image or image piece estimated by the error concealment algorithm 513 is also integrated into the video signal 509, but, in a variant, the video signal 509 may be corrected with a different error concealment algorithm.

It is to be noted that the correction filter 415 is not indispensable to the implementation of the decoder according to the invention. However, if it is present at the encoder, it is advantageous for it to be present at the decoder also.

FIG. 6, describes embodiments of the resilience filter 417 of the coder or 510 of the decoder, in detail.

This filter may be uniform on the surface of the image and invariable from one image to the next. However, when this filter is parameterized, the efficiency of the method in terms of rate-distortion and of resilience against errors increases.

In FIG. 6, the selection module 609 supplies, to the resilience filtering module 610 (which in the preceding Figures, is either module 417 at the coder, or module 510 at the decoder), a matrix called blur intensity matrix C or processing intensity matrix of the same size as the reference image in this embodiment.

The coefficients C_{i,j} of this matrix represent the number of times that the blurring mask 610 is applied to each pixel of the processed image. For example, in the preferred embodiment, the blurring mask for the current pixel is a full block of size 3×3 pixels which is convoluted with the current pixel. In a scenario in which a uniform application of the resilience filter is applied over the whole surface of the image, all the coefficients C_{i,j} are equal to 1.

In the embodiment described, the convolution is carried out by calculating the pixel of the blurred reference image 611 as being equal to the average of the pixel of the same position in the reference image 601 with its 8 neighboring pixels. When the pixel is at the edge of the image, the filter is adapted according to the number of pixels available.

In the algorithm provided in this embodiment, if the coefficient C_{i,j} of the blur intensity matrix is different from 0, the mask is applied, then the coefficient is decremented by one unit. The mask is applied over the whole of the image until the intensity matrix contains solely coefficients equal to zero.

According to one embodiment, the blur intensity matrix may depend on one or more modules (modules 602 to 608 in FIG. 6), which makes it possible to improve the performance of the coder in terms of rate-distortion and robustness to errors. The switches in FIG. 6 symbolize the fact that only one or on the contrary several of these modules may be used at the same time.

The modules used are respectively based on the value of the gradient of each pixel 602, the value of the motion vectors of each pixel (or block) 603, the statistics of the network 604, the type of the image 605, the quality aimed at 606 (determined by virtue of the quantization step size QP), the number of images per second 607 and the proximity of an Intra image 608.

The blur intensity matrix is initialized image by image with the value C_{i,j}=0 for all the values of (i,j). The coefficients of the intensity matrix are integers.

The gradient of the image, representing the spatial variability of the image signal, is known in particular for its use in processing the image to characterize edges. The gradient may be calculated on each of the components using the Sobel algorithm. In this algorithm, each pixel of position (i; j) of the image undergoes two convolutions, one to determine the component along the x-axis of the gradient G_{X}^{i,j} and the other to determine the component along the y-axis of the gradient G_{Y}^{i,j}.

These components are defined as follows:

$${G}_{X}^{i , j} = [ \begin{matrix}- 1 & 0 & 1 \\ - 2 & 0 & 2 \\ - 1 & 0 & 1\end{matrix} ] * A and {G}_{Y}^{i , j} = [ \begin{matrix}1 & 2 & 1 \\ 0 & 0 & 0 \\ - 1 & - 2 & - 1\end{matrix} ] * A$$

where A is the 3×3 matrix containing the current pixel in central position and the 8 pixels neighboring the current pixel. The gradient G^{i,j} for the pixel of the reference image at the position (i; j) is defined by

$${G}^{i , j} = \sqrt{{G}_{X}^{i , {j}^{2}} + {G}_{Y}^{i , {j}^{2}}}$$

The value of the coefficient (i; j) of the intensity matrix is incremented by a value proportional to G^{i,j} denoted

$$\frac{{G}^{i , j}}{δ} ,$$

δ being an adjustment parameter. When module 602 alone is activated, the coefficients of the blur intensity matrix are solely dependent on the gradient and are equal to:

$${C}_{i , j} = E ( \frac{{G}^{i , j}}{δ} )$$

where E(X) is equal to the integer immediately below the real value of X.

Thus, the surfaces that contain few high frequencies, and for which the gradient G^{i,j} is small, are only blurred a little, or even not blurred at all. On the contrary, the more a surface contains high frequencies the higher the intensity of the blur. The parameter δ is set at 10 if only the switch for the gradient module 602 is activated.

If other switches are closed, the parameter δ may have another value. According to one embodiment, the parameter δ is chosen according to the intended application, the quantity and the frequency of the losses, and the size and the content of the sequences. The parameter δ, as well as those described later (δ_{MVT}, δ_{R}, λ_{R}, τ), are advantageously chosen empirically.

The result of the above is that the operation of the resilience filter depends, via module 602, in particular on the content of the image to filter, which is taken into account here by the gradient calculation.

Discontinuities in the motion are also characterized by virtue of a motion gradient. In the video coding standards, a macroblock is segmented into several blocks, the 4×4 block is the smallest size used and a motion vector is attributed to each block.

In the embodiment described, with reference to the module 603, a gradient is calculated for each of the components, horizontal and vertical. The so-called “motion” gradient, denoted G_{MVT}, is the sum of the gradients of each of the components (horizontal and vertical) of the vector. This gradient is obtained by the following formula:

$${G}_{MVT}^{i , j} = \sqrt{{{G}_{MVT}^{V}}_{X}^{i , {j}^{2}} + {{G}_{MVT}^{V}}_{Y}^{i , {j}^{2}}} + \sqrt{{{G}_{MVT}^{H}}_{X}^{i , {j}^{2}} + {{G}_{MVT}^{H}}_{Y}^{i , {j}^{2}}} .$$

$${{G}_{MVT}^{V}}_{X}^{i , j}$$

is the X component of the gradient of the vertical component of the vector for position (i; j).

$${{G}_{MVT}^{V}}_{Y}^{i , j}$$

is the Y component of the gradient of the vertical component of the vector for position (i; j).

$${{G}_{MVT}^{H}}_{X}^{i , j}$$

is the X component of the gradient of the horizontal component of the vector for position (i; j).

$${{G}_{MVT}^{H}}_{Y}^{i , j}$$

is the Y component of the gradient of the horizontal component of the vector for position (i; j). The pixels composing the block all have the same value of motion gradient. For each pixel, this gradient is denoted G_{MVT}^{i,j}.

In a scenario in which the coefficients C_{i,j} of the blur intensity matrix have already been updated with the gradient of the reference image 602, the motion gradient serves for weighting that blur intensity to take into account the temporal variability of the image stream.

If the motion gradient is sufficiently small, according to the formula

$$\frac{{G}_{MVT}^{i , j}}{{δ}_{MVT}} < τ ,$$

τ being a limit parameter, for example equal to 3, and δ_{MVT} being an adjustment parameter for example set to 5, and if the coefficient of the blur intensity matrix is not zero (C_{i,j}≠0), the latter is then decremented by one unit (C_{i,j}=C_{i,j}−1).

Otherwise, the coefficient of the blur intensity matrix is increased by a value proportional to the motion gradient according to the formula

$${C}_{i , j} = {C}_{i , j} + ⌊ \frac{{G}_{MVT}^{i , j}}{{δ}_{MVT}} ⌋ .$$

It is to be noted that the value of the parameter δ_{MVT} is advantageously set according to the other modules activated for the calculation of the blur intensity matrix.

The use of module 603 thus makes it possible to protect the regions of motion discontinuity, or of strong motion. To be precise, the algorithms for error concealment by extrapolation are less efficient in these regions. The use of the most blurred reference images in these regions thus enables the propagation of errors to be reduced, by enriching the high frequency residues transmitted. The increase in the blur intensity in these regions enables better reconstruction to be ensured.

The result of the above is that, in one embodiment, the operation of the resilience filter is dependent, via module 603, in particular on compression information of the images, this information being sent in the bitstream 410 and 501, and being motion vectors of the block residues in the present case.

Furthermore, in one embodiment in which the coding is live coding, the statistics of the network 604 may be known by the coder and the decoder. These statistics then allow the blur intensity to be adapted during step 609.

For example, in course of a scenario in which the coefficients of the blur intensity matrix have already been updated by one or more other modules, and in a situation in which the coder and the decoder know the rate of packet loss, this loss rate is used to determine the variables δ_{R} and λ_{R} (which values are positive or zero) which enables the coefficients of the blur intensity matrix to be updated such that C_{i,j}=C_{i,j}×δ_{R}+λ_{R}. In the embodiment of FIG. 6, the higher the loss rate, the more the coefficient of the blur intensity matrix is increased, such that the blurring mask is applied a higher number of times. On the contrary, the lower the loss rate, the closer the values δ_{R} and λ_{R} are chosen to 1 and 0 respectively, that is to say that the module 604 is not used.

The result of the above is that, in one embodiment, the operation of the resilience filter depends, via the module 604, in particular on an analysis of the information received by the decoder via the network, which is the loss rate in the present case.

Still in the embodiment of FIG. 6, the coefficients of the blur intensity matrix are differently weighted, via the module 605, when the reference image is a P image and when it is a B image. In the described embodiment, the coefficient is higher (for example three times higher) if the image is a P image than if it is a B image, such that the blurring mask is applied a higher number of times.

This is because an error in a P image affects a higher number of images than an error in a B image, since the P images are not dependent on the B images, so as to be usable in certain applications. Furthermore, the error concealment algorithms are more effective for B images than for P images. Generally, greater difficulties result from this concerning P images than concerning B images.

The result of the above is that, in one embodiment, the operation of the resilience filter is dependent, via module 605, in particular on compression information of the images, this information being sent in the bitstream 410 and 501, and being the compression modes of the Inter images in the present case.

The number of images per second, or speed of the image stream, supplied by the module 607, affects the efficiency of the error concealment algorithms. To be precise, the closer the images temporally, the more precise is the motion extrapolation. The number of images per second thus affects the error propagation, and it is therefore advantageous to weight the coefficient of the blur intensity matrix on the basis of a parameter dependent on the number of images per second, which parameter is denoted Iₛ with

$${I}_{s} = \frac{Fr}{25}$$

where Fr is the number of images per second. For example, Iₛ=1 for a stream of 25 images per second and Iₛ=2.4 for a stream of 60 images per second. The coefficient of the intensity matrix is divided by Iₛ, according to the formula

$${C}_{i , j} = \frac{{C}_{i , j}}{{I}_{s}} .$$

Lastly, the quality of encoding, in the H.264/AVC stream, depends on the quantization step size (QP) used in the quantization process. At low throughput, or high quantization, the high frequencies of the signal naturally disappear and the blocks rarely contain high or medium frequencies.

The majority of the bitstream is then composed of motion information. The application of the resilience filter to the reference images has little impact on the propagation of errors and causes a reduction in the coding efficiency. The coefficients of the blur intensity matrix are advantageously chosen to be less than those used for the high throughputs. In FIG. 6, this is controlled by the module 606, which determines whether the value of QP is high, for example higher than a predetermined value.

Lastly, it is known that in a video stream, Intra images are regularly integrated in order to refresh the sequence in case of loss.

In one embodiment of the invention, the coefficients of the blur intensity matrix have greater weighting according to the distance between the reference image and the following Intra image. In FIG. 6, this weighting is controlled by the module 608, which gives the proximity of the closest Intra image. It is found that the propagation of an error occurring on an image has less impact if the image occurs just before an Intra image.

The result of the above is that, in one embodiment, the operation of the resilience filter is dependent, via module 608, in particular on compression information of the images, this information being sent in the bitstream 410 and 501, and being the compression modes of the successive images in the present case.

Modules 602 to 608 enable the resilience filter preferentially to filter the high frequencies of original content contained in the reference images 508, that is to say the high frequencies which were present in original sequence 401, and which were not introduced in the images by the process of segmentation, compression, coding, decoding, decompression and reconstitution of the image. The resilience filter in the embodiment of FIGS. 4 and 5 is applied to the whole of the surface of the image according to modules 602 to 608, in particular within the blocks.

The same resilience filter 610 is applied using the same algorithm at the coder and at the decoder. At the decoder, the general operating parameters of the modules 602 to 608 used are either determined for a given lapse of time by a message from the coder to the decoder, or are set in fixed manner in the same way as in the implementation of the coder.

The modules 602 to 609 of the decoder analyze the decoded images contained in module 508 and use the other items of information referred to, which are available in the same way at the decoder and at the encoder, and construct a matrix C identical to that constructed previously by the modules 602 to 609 of the coder.

It can be understood that the matrix C may be marginally different if the bitstream has been damaged. This is because, if the current image contained in the module 416 at the coder and the corresponding decoded image contained in the module 508 at the decoder are different, the module does not then calculate strictly the same value for gradient G.

Similarly, after a loss, the motion vectors of the current image are not available, and in these cases the module 603 at the decoder is applied to the vectors calculated by the concealment algorithm 513, and does not supply strictly the same parameters as those used by the coder.

Nevertheless, the application of the resilience filter to the decoder is made so as to obtain an improved visual quality, on account of the resilience against the high frequency losses referred to above.

According to an alternative embodiment represented in FIG. 7, in which the reference numbers are modified relative to those of FIG. 4 by the addition of 300, the motion estimating step implemented by the module 604 is carried out on the basis of the non-blurred reference images 716. The whole of the rest of the coder is identical to the embodiment of FIG. 4. The step of block extraction 722 is made in the non-blurred reference images 716. The steps of block extraction 712 and 723 are however carried out in the blurred reference images 718. The decoder used is that of FIG. 5.

As in the preceding embodiment, the technical effect of resilience against high frequency losses and of improvement in visual quality is obtained.

Relative to the embodiment of FIG. 4, the motion compensation 404 is carried out with a block extracted from the blurred images 718, and having the same position in the image as the block chosen by the motion estimation 704 within the non-blurred images.

It is to be noted that the embodiment of FIG. 4 enables an improved compression efficiency to be obtained relative to the embodiment of FIG. 7, since the motion compensation 405 is carried out with the block actually chosen at the time of the motion estimation 404. In certain cases, in which the resilience filtering leads the motion estimation module to choose a different block to that which would be chosen without the application of the resilience filtering, the compression is sub-optimal in the embodiment of FIG. 7.

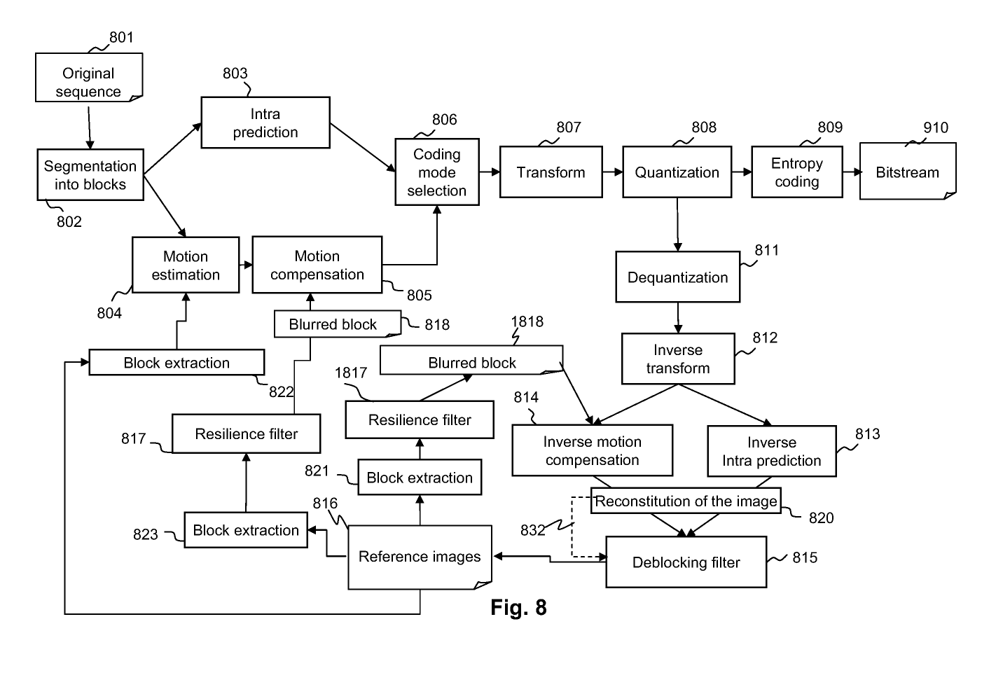

According to an alternative embodiment represented in FIG. 8, in which the reference numbers are modified relative to those of FIG. 7 by the addition of 100, the filtering step is dissociated into a first filtering step implemented by a module 817 and a second filtering step implemented by a module 1817. The filtering step 817 and the block extracting step 821 are chronologically inversed relative to what is presented in FIG. 7, and the filtering step 1817 and the block extracting step 823 are also chronologically inversed.

Instead of a blurred reference image, a blurred block 818 and 1818 is kept. The blurred block 818 serves for the motion compensation 805, and the blurred block 1817 for the inverse motion compensation 814. The whole of the rest of the coder is identical to the embodiment of FIG. 7. The decoder used is that of FIG. 5.

In this variant, it can be understood that the blur filters 817 and 1817 do not use the neighboring pixels of the extracted blocks. The effect sought of resilience against the loss of high frequencies is attained, as in the preceding embodiments.

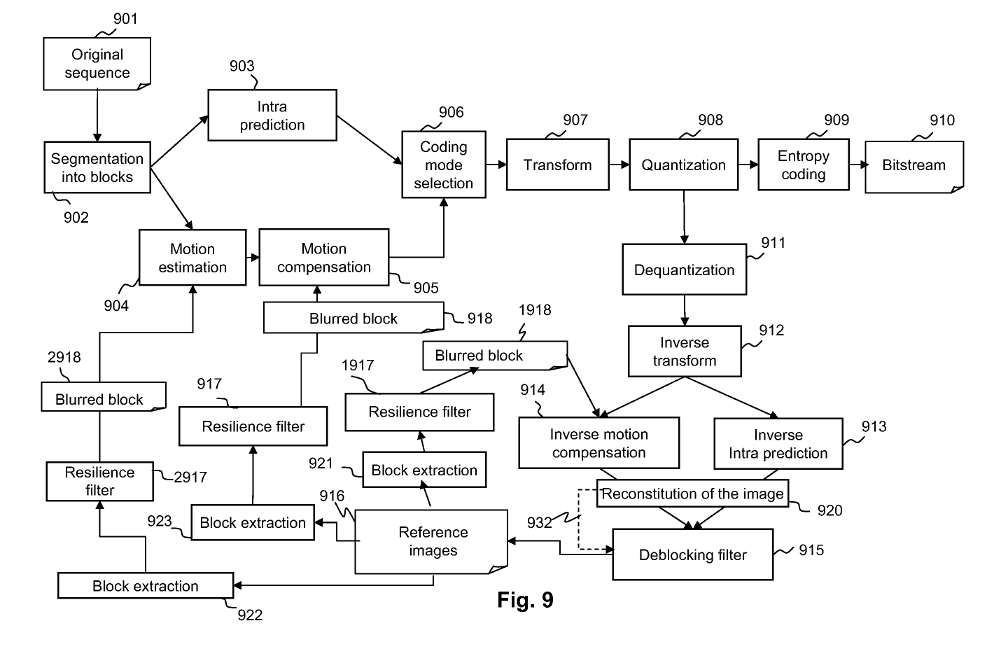

In an alternative embodiment represented in FIG. 9, all the elements of the embodiment of FIG. 8 are retained, and a filter 2817 is added that is identical to the filter 817 and 1817 between the bloc extraction module 822 and the motion estimation module 804. This filter 2817 produces blurred blocks 2818 used for the motion estimation, which enables the efficiency of the coding to be improved. The decoder used is that of FIG. 5.

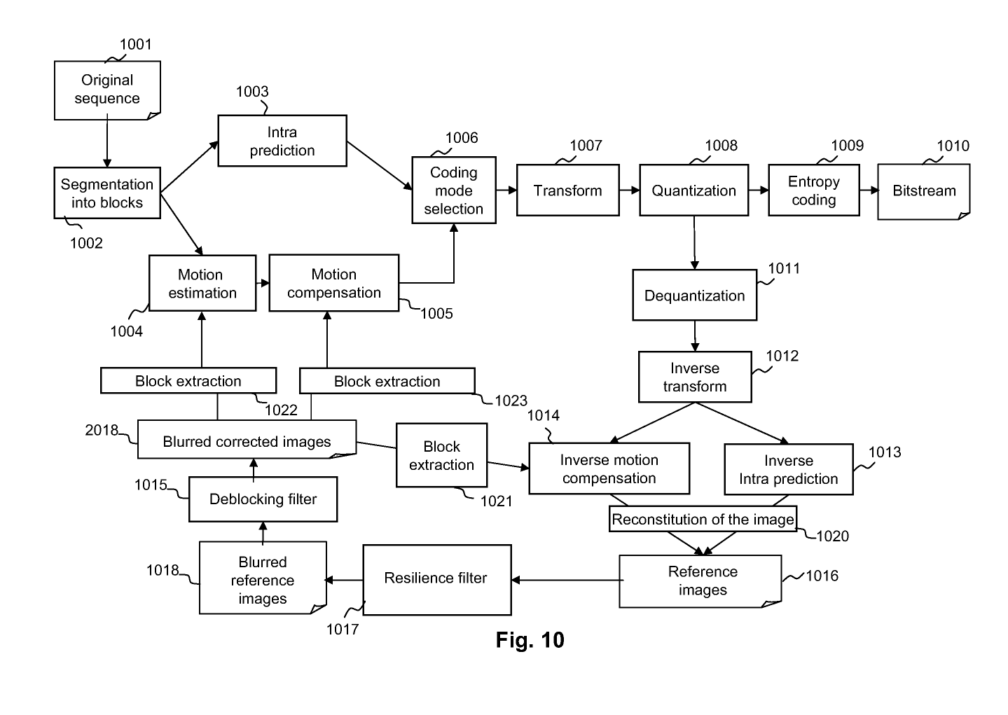

According to an alternative embodiment represented in FIG. 10, in which the reference numbers are modified with respect to those of FIG. 4 by the addition of 600, the step of resilience filtering and the step of applying the deblocking filter are chronologically inversed.

After the reconstitution 1020 of the untreated reference image 1016, the resilience filter 1017 according to the invention is applied, to obtain a blurred reference image 1018. A de-blocking filter 1015 is then applied, which uses an item of information (not represented) coming from the module 1020 for reconstitution of the image, which leads to the blurred and corrected images 2018. The block extractions 1031, 1022 and 1023 are carried out on the basis of the blurred and corrected images. The decoder used is that of FIG. 5.

Thus in this embodiment, a step of deblocking filtering is introduced between the step of resilience filtering and the step of calculating a residue.

In this embodiment, the deblocking filter attenuates the high frequencies created by the process of quantization, while the resilience filter 1017 attenuates the high frequencies of the original signal which are thus kept in the block residues.

According to a variant, an item of information is sent from the resilience filter 1017 to the deblocking filter 1015, and a module 612 “Other filtering” is present in parallel with the modules 602 to 608 of FIG. 6. The resilience filter 1017 is not then applied to the block boundaries, the effect of which is to improve the performance, filtering being applied only once at the block boundaries.

It is to be noted that the variants presented in FIGS. 8 to 10 may be combined.

According to an alternative embodiment of the decoder (not shown, but which may be deduced from FIG. 5), the resilience filter 510 is placed before the deblocking filter 507 for the production of the reference images for the inverse motion compensation 506. As previously, only the deblocking filter is applied for the production of the video signal 509.

The invention is not limited to the described embodiments, but covers all the variants within the capability of the person skilled in the art.

What is claimed is:

1. A method of coding a stream of images that are divided into blocks comprising, for a block to code, a motion compensating step during which a residue is calculated from said block to code and from a reference block chosen as predictor, characterized in that it comprises
a step of resilience filtering (417; 717; 817; 917; 1017) applied to at least one reference block, during which high frequencies of original content of at least one part of the reference block are filtered to obtain a blurred reference block,
a step of calculating a residue enriched with high frequencies (405; 705; 805; 905; 1005) using the blurred reference block as predictor in a motion compensating step, and
a step of processing (407-409; 707-709; 807-809; 907-909; 1007-1009) said residue for it to be coded.

2. A coding method according to claim 1, characterized in that the processing step comprising a step of quantizing (408; 708; 808; 908; 1008) the residue, the reference block is obtained by a step of preparing (411-415; 420; 711-715, 720; 811-815, 820; 911-915, 920; 1011-1014, 1020) the reference block including a step of dequantizing (411; 711; 811; 911; 1011) a block residue.

3. A coding method according to claim 1, characterized in that the reference block is obtained by a step of preparing the reference block (411-415; 420; 711-715, 720; 811-815, 820; 911-915, 920; 1011-1014, 1020) including a predicting step which, when it is an inverse motion compensating step (414; 714; 814; 914; 1014), uses a decoding predictor block, itself obtained by a step of preparing the decoding predictor block that includes a step of resilience filtering (417; 717; 1817; 1917; 1017).

4. A coding method according to claim 1, characterized in that it further comprises, prior to a motion estimating step (404; 704; 804; 904; 1004) during which the reference block is selected, a step of image reconstituting (420; 720; 820; 920; 1020) and a step of correction filtering (415; 715; 815; 915; 1015) that filters the high frequencies on the basis of a characteristic (432; 732; 832; 932; 1032) of the image reconstituting step.

5. A coding method according to claim 1, characterized in that the step of resilience filtering comprises at least one application of a blurring mask to a pixel, consisting of replacing the value of said pixel by the average of the values of at least one set of pixels that are neighbors of said pixel.

6. A coding method according to claim 1, characterized in that the step of resilience filtering comprises a step of determining a matrix of intensity of processing comprising for each pixel of the reference image a value representing an intensity of processing to be carried out.

7. A coding method according to claim 1, characterized in that the step of resilience filtering is carried out on the basis of at least one value representing a spatial variability (602) of at least one reference block.

8. A coding method according to claim 1, characterized in that the step of resilience filtering is carried out on the basis of at least one value representing a temporal variability (603) of at least the reference block.

9. A coding method according to claim 1, characterized in that the step of resilience filtering is carried out on the basis of at least one indicator of a coding mode of the image of which the reference block (605) forms part.

10. A coding method according to claim 1, characterized in that the step of resilience filtering is carried out on the basis of at least one speed of the video image stream (607).

11. A coding method according to claim 1, characterized in that the step of resilience filtering is carried out on the basis of at least one temporal distance (608) between the block to which the resilience filtering is applied and an image coded autonomously later.

12. A coding method according to claim 1, characterized in that the step of resilience filtering is carried out on the basis of at least one parameter representing a traffic state of a network (604) over which the stream of images is transmitted.

13. A coding method according to claim 1, characterized in that the step of resilience filtering is carried out on the basis of at least one quantization step size (606) used in the residue processing step.

14. A method of decoding a stream of images that are divided into blocks comprising, for a residue to decode, an inverse motion compensating step during which a block is calculated from said residue to decode and from a reference block serving as predictor, characterized in that it comprises
a step of resilience filtering (510) applied to at least one reference block, during which high frequencies of at least one part of said reference block are filtered to obtain at least one blurred reference block, and
a step of calculating a decoded block (506) using the blurred reference block as predictor in an operation of inverse motion compensation.

15. A decoding method according to claim 14, characterized in that if a loss of data from the image stream is identified (512) before the reference filtering step (510), an error concealment algorithm (513) using motion extrapolation is used to replace the lost data.

16. A device for coding a stream of images that are divided into blocks adapted to perform, for a block to code, motion compensation during which a residue is calculated from said block to code and from a reference block chosen as predictor, characterized in that it comprises
means for resilience filtering (417; 617; 717; 817; 917; 1017) adapted to be applied to at least one reference block, to filter high frequencies of original content of at least one part of the reference block and obtain a blurred reference block
means for calculating a residue enriched with high frequencies (405; 605; 705; 805; 905; 1005) adapted to use the blurred reference block as predictor in a motion compensating step, and
means for processing (407-409; 607-609; 707-709; 807-809; 907-909; 1007-1009) said residue for it to be coded.

17. A device for decoding a stream of images that are divided into blocks adapted to perform, for a residue to decode, inverse motion compensation during which a block is calculated from said residue to decode and from a reference block serving as predictor, characterized in that it comprises
means for resilience filtering (510) adapted to be applied to at least one reference block, for filtering high frequencies of at least one part of said reference block and to obtain at least one blurred reference block, and
means for calculating a decoded block (506) adapted to use the blurred reference block as predictor in an operation of inverse motion compensation.

18. A computer program comprising a series of instructions adapted, when they are executed by a microprocessor, to implement a method according to claim 1.

19. A computer program comprising a series of instructions adapted, when they are executed by a microprocessor, to implement a method according to claim 14.
